(19) United States
(12) Patent Application Publication
(10) Pub. No.: US 2012/0179856 A1
(43) Pub. Date: Jul. 12, 2012

(54) E-medstick, e-medstick, e-medstick EMR

(76) Inventor: Arthur Laurence Smith, JR., Phoenix, AZ (US)

(21) Appl. No.: 12/658,578

(22) Filed: Apr. 5, 2010

Related U.S. Application Data
(60) Provisional application No. 61/209,337, filed on Mar. 6, 2009.

(51) Int. Cl. G06F 12/00

(52) U.S. Cl. 711/103; 711/E12.008

(57) ABSTRACT

A device stores a patient's medical records to solve the problems of incompatibility of electronic medical record systems, no patient information available at emergencies, lack of information sharing among physicians, and health care fraud. The device includes a flash drive configured to connect to a USB port and be read by a computer, a record of emergency patient data photo stored on the flash drive and displayed immediately by the computer when the flash drive is inserted into the USB port, and a record of detailed data stored on the flash drive and displayed upon entry of a correct password and identification.

### TECHNICAL FIELD

This invention generally relates to the field of healthcare and medical services. The invention specifically relates to storage of individual medical records on a portable electronic medium in order to provide personal medical information to all healthcare providers.

### BACKGROUND

All of us are in a continued state of medical risk—even close at home—any accident for that matter is impossible to predict. Such medical risk can occur in a split-second. Everyone needs to be prepared for the unexpected. Wouldn't you want your physician and family to know when you are in a medical emergency? Suppose you are unconscious? How are the emergency people going to know what your system is all about, what medications and health challenges you may have, who your healthcare providers are, what medication allergies you may have or what special health care conditions you may have?

Presently, many medical records (in paper form) are not safe and secure, are subject to being misused, stolen, damaged, destroyed, mutilated and can be viewed without authorization. In addition, prior medical records are not available to new healthcare providers, including those in foreign countries or away from home. Furthermore, paper records can be bulky and cumbersome.

While a few health care providers have implemented the Electronic Medical Record (EMR and more have not—these latter perhaps preferring to let the industry ‘mature’) the fact still remains that the EMR is one of the most important items in the health care system—outside of the physician/provider themselves. The term Patient Centered Care System is focused on the patient as the recipient of the health care system. Mostly this is used when a certain vendor provides the systems for a specific client who may have one or more locations where the systems are installed. Thus when a patient travels to another location (within the same provider) the patient medical records are available via computer/Internet.

A Patient Centered Health Care System means that when patients' medical records are electronically recorded for instance at their primary care physician and should the patient go to another provider where their records are available by computer to the other provider they go to. In essence both providers are on the same system. For instance, the patient lives in town A and they go to town D in a different state, province, etc., for treatment. Their records are available to the new provider they go to merely by the new provider entering the patient ID since the new provider is on the same system.

Sounds good, nice and easy, but it isn't because the new provider the patient goes to may not be on the same system, or the new provider while on a system may not be on the same system as where the patient is from originally while both systems may perform similar functions they still may not be compatible and do not talk to one another. Thus, this could be a major concern for both the patient and the staff at the new or other provider he is to be treated as well as for the patient's primary care physician as by being treated at the other provider there is now new information which the primary care physician should have for his records. And what about emergencies and other health challenges? And the same goes for the new provider that treated the patient they need to know what the primary care physician (and other providers) has done for the patient so they do not duplicate such treatment, prescriptions, procedures, costs, etc.

Electronic Medical Records (EMR) in those places where they have been implemented and accepted and the people trained to properly use the systems have been found to have a more responsive system for staff and patients. This promotes preventative medicine, facilitates research and improves billing. Healthcare providers can work proactively with patients regarding healthcare planning including electronic medication renewals and appointment scheduling. Moreover, the EMR facilitates quick accurate medical diagnosis and treatment because detailed data regarding current health, medications, allergies, surgeries and vaccinations, including records of treatments, dates and doctor reports is quickly available. The EMR provides instant access to data by multiple users and stores and displays high quality x-rays, graphics and accompanying doctors reports. This also allows sharing of complete medication lists where desired. Significantly, records are easily updated as many times as needed; the data is encrypted for security to ensure that the patient's medical identify is safe.

Nonetheless, it is difficult for a truly integrated system to be implemented since all vendors and suppliers do not use compatible EMR systems. Despite the fact that every systems performs essentially the same functions, there is no cross-compatibility. While one system from one vendor will work well for a specific client, that same system may not work well for a different client.

Moreover, EMR lacks wider implementation because most physicians and other health care providers do not like the expense of installation and use. A recent article by Dr. Bill Cast discusses this.

“How do we know doctors hate EMR's? Look at anemic adoption rates. Big clinics and large physicians' groups lead the way in buying them, but the most optimistic statistics say that fewer than 50% of even large groups have EMRs. Overall, perhaps 20% of physicians have EMR, but for small groups the best guess is 5%. And, when such features as e-prescribing, e-visit, and PHR integration are considered, it is likely than less than half of physicians use their EMR for little more than their own templates and a few favorite features. The majority of physicians have voted with their feet.”

In the business community it is common to hear doctors referred to as computer-phobic and “in denial” about the benefits of computing. That is wonderfully ironic when heard alongside chronic complaints that doctors are overly eager to use expensive technology: lasers, cryro-probes, fiber optics, MRI and PET scanners, stents, and implants. The fact is that doctors love high-tech. They have reason to hate EMRS but not computers and iPhones. This was confirmed at a Healthvault meeting in Redmond (WA) when a physician panel member, representing a leading medical association, was asked: “Why are physicians so recalcitrant to use EMR?” He responded: “They are not recalcitrant; they are in open rebellion! Why? Because the software you give them is garbage. It slows them down!” In other words, it is not that the software is too expensive, but that doctors cannot afford to use it.

### BRIEF DESCRIPTION OF THE DRAWINGS

FIG. 1 shows the Personal Information screen. No Internet access or password is required to view this information.

FIG. 2 shows a privacy notice that must be accepted before any information can be viewed.

FIG. 3 shows a log-on screen where the patient or authorized user must enter a user ID and password in order to view private health information.

FIG. 4 shows the Personal Information visible only after entering a valid user ID and password.

FIG. 5 shows a Chart Summary visible only after entering a valid user ID and password.

FIG. 6 shows the Allergies/Intolerances screen visible only after entering a valid user ID and password.

FIG. 7 shows the Imaging/X-Ray Report Screen visible only after entering a valid user ID and password.

FIG. 8 shows the Lab Reports screen visible only after entering a valid user ID and password.

FIG. 9 shows the Immunization Record screen visible only after entering a valid user ID and password.

FIG. 10 shows the Pathology Reports screen visible only after entering a valid user ID and password.

FIG. 11 shows the Medications screen visible only after entering a valid user ID and password.

FIG. 12 shows the Most Recent Progress Notes screen visible only after entering a valid user ID and password.

FIG. 13 shows the Past Medical History screen visible only after entering a valid user ID and password.

FIG. 14 shows the Past Surgical History screen visible only after entering a valid user ID and password.

FIG. 15 shows the Family History screen visible only after entering a valid user ID and password.

FIG. 16 shows the Social History screen visible only after entering a valid user ID and password.

FIG. 17 shows the Review of Systems screen visible only after entering a valid user ID and password.

FIG. 18 shows the Provider Chief Complaints screen visible only after entering a valid user ID and password.

FIG. 19 shows a screenshot of More X-Ray Examples visible only after entering a valid user ID and password.

FIG. 20 shows a screenshot of Vision Test visible only after entering a valid user ID and password.

FIG. 21 shows a screenshot of Prostate Photos/Charts visible only after entering a valid user ID and password.

FIG. 22 shows a screenshot of Prostate Photos/Charts visible only after entering a valid user ID and password.

FIG. 23 shows a screenshot of X-Ray Examples visible only after entering a valid user ID and password.

FIG. 24 shows a screenshot of a scan of an audio test visible only after entering a valid user ID and password.

FIG. 25 shows a Personal Information screen in the German Language visible only after entering a valid user ID and password.

FIG. 26 shows the first page of the Personal Information Form.

FIG. 27 shows the second page of the Personal Information Form.

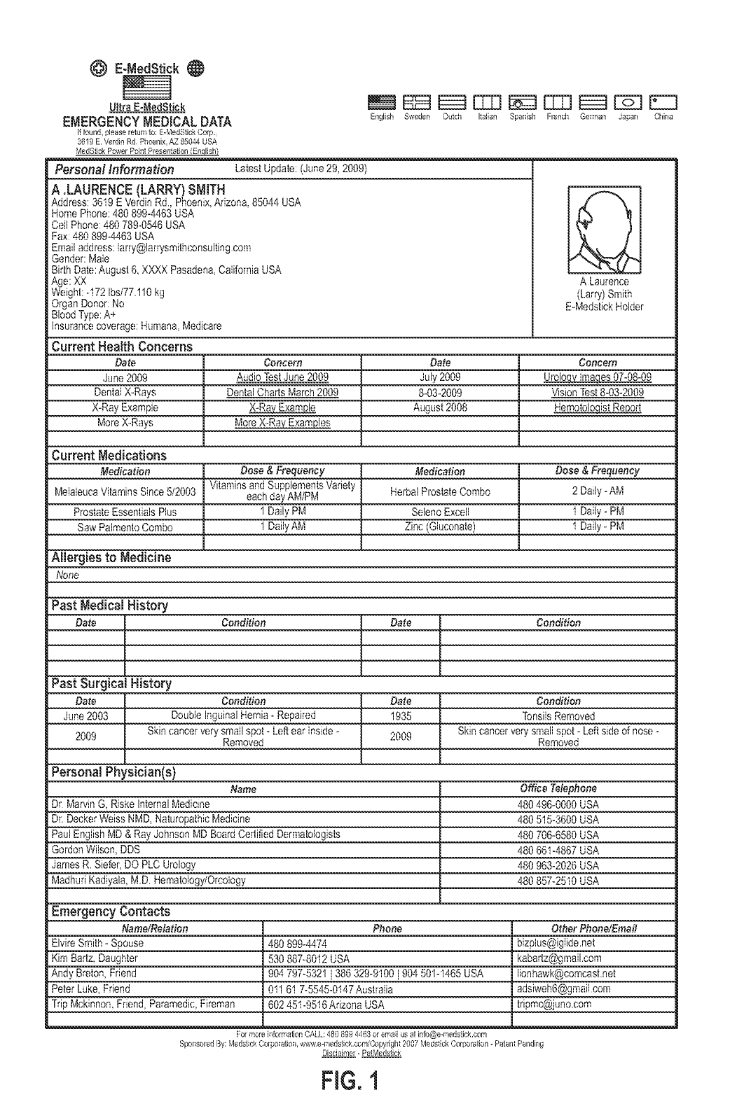

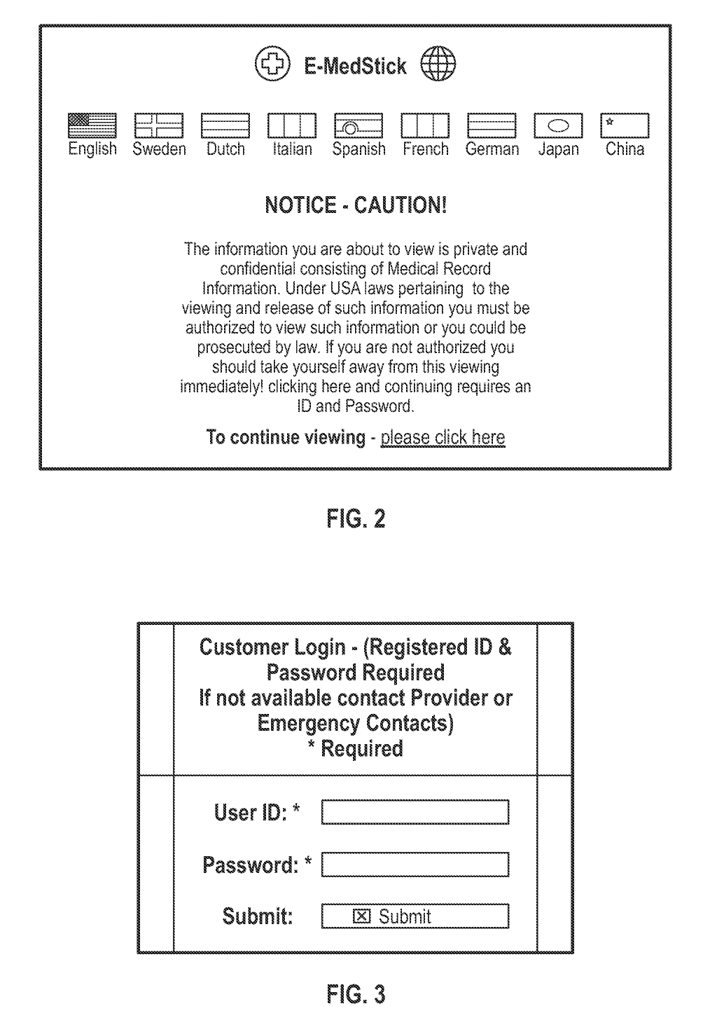

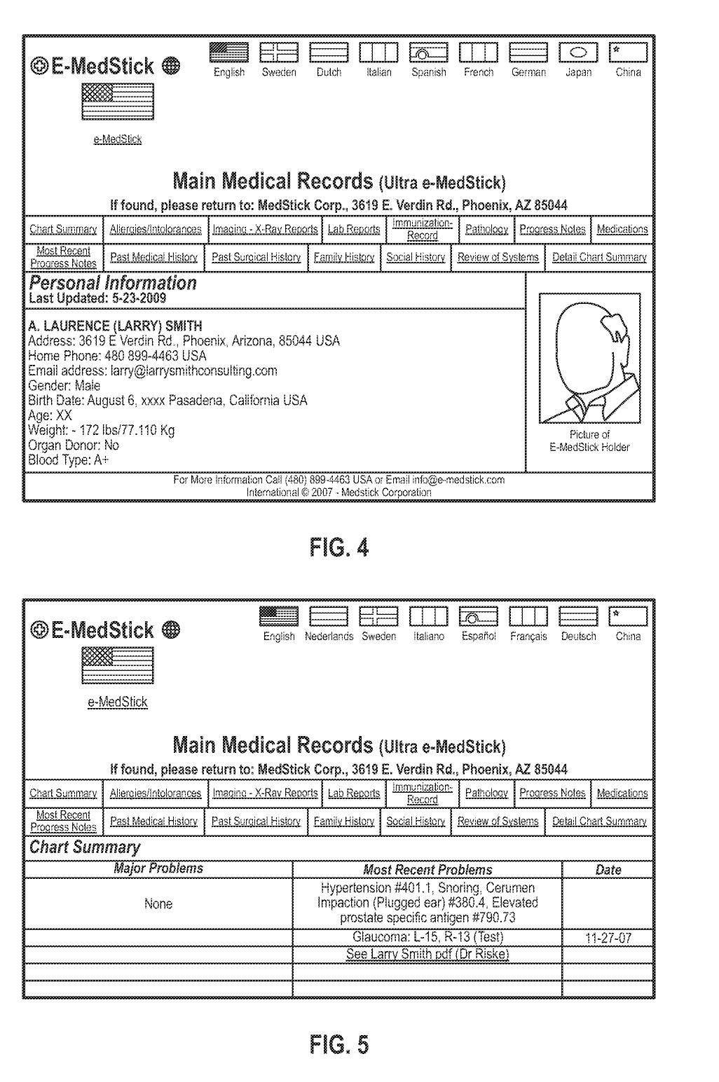

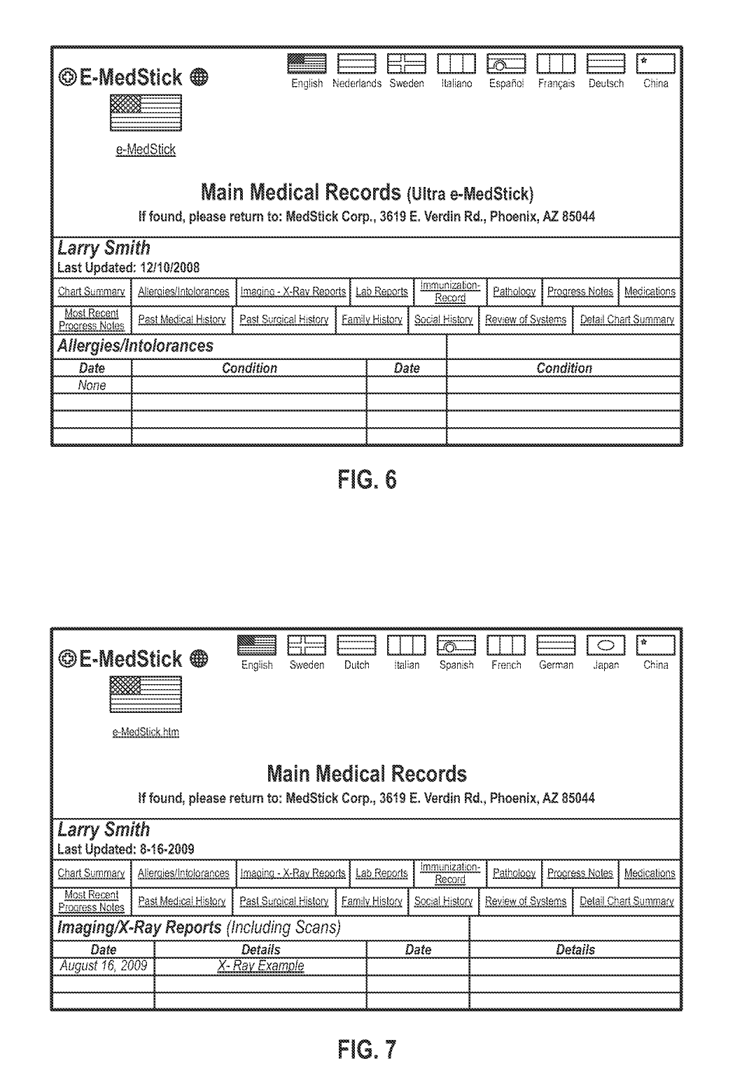

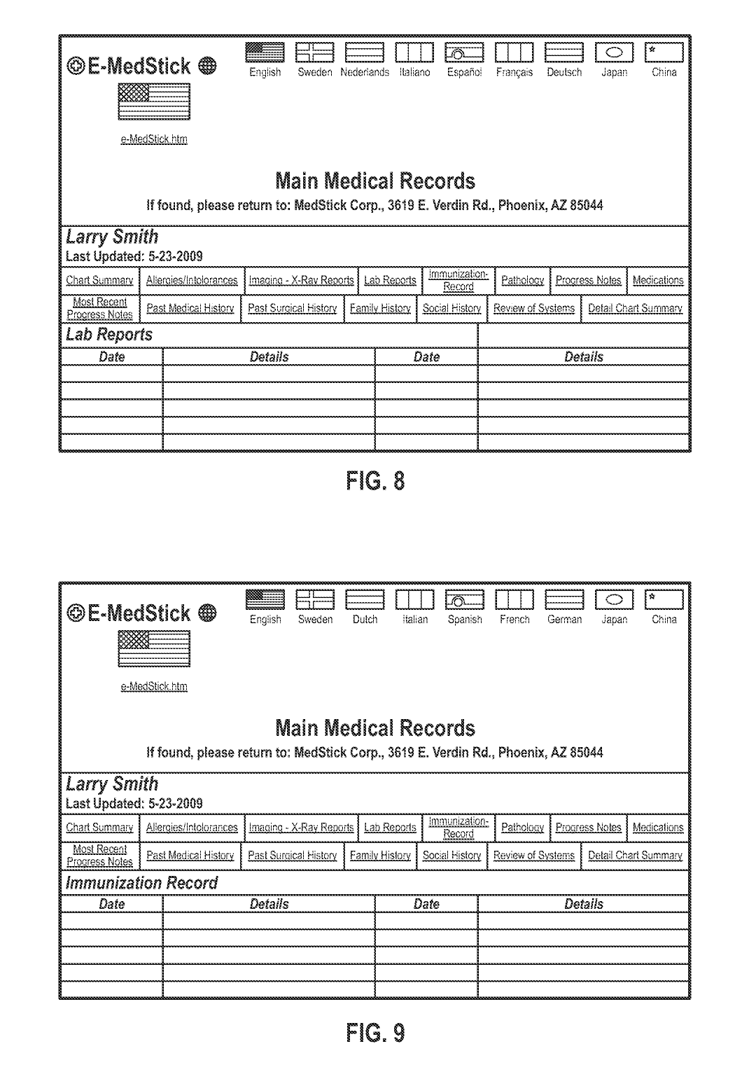

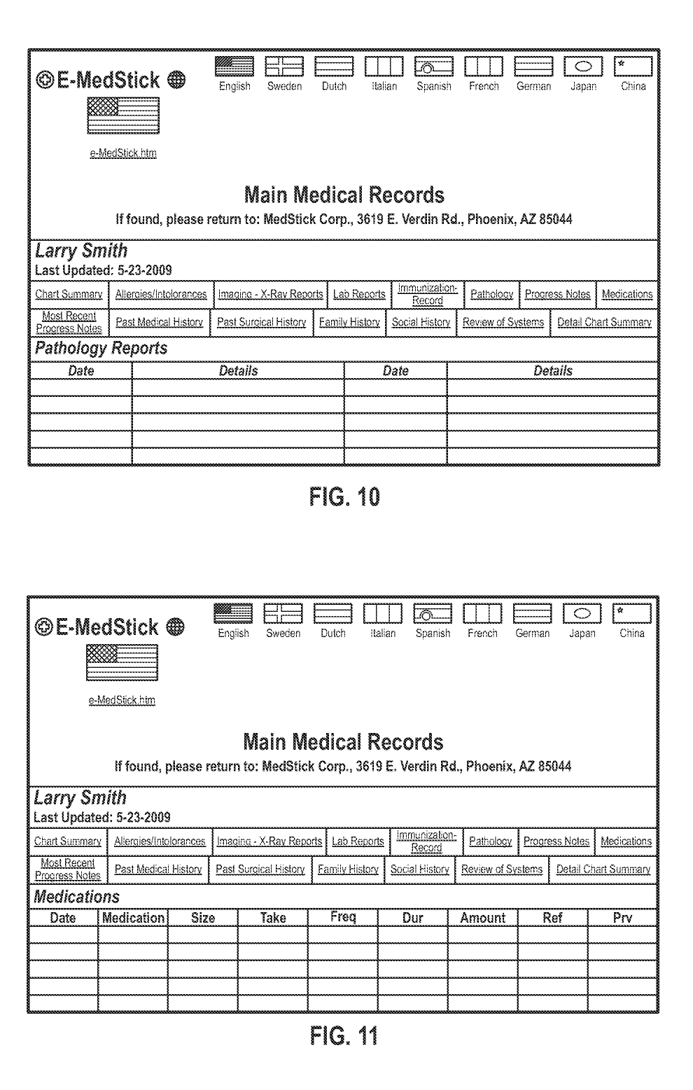

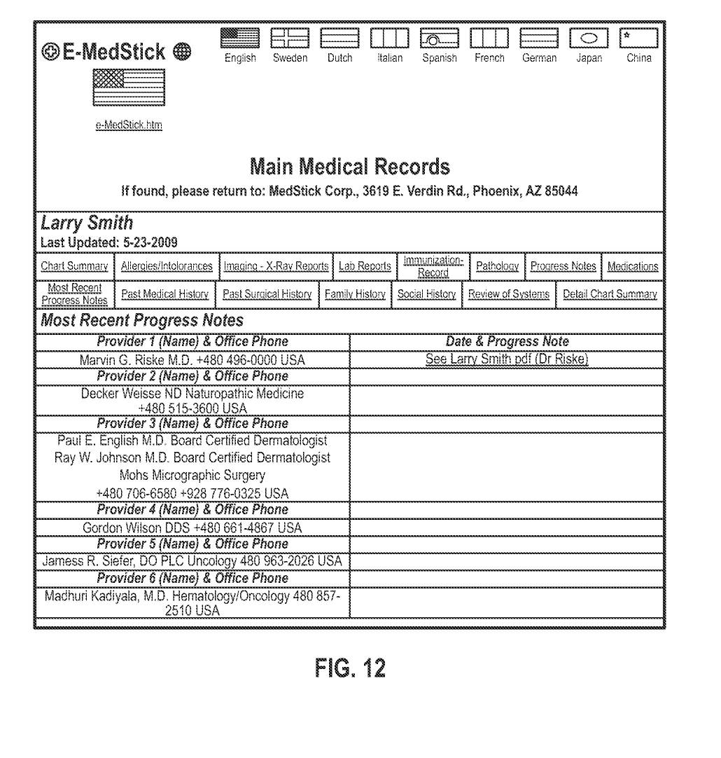

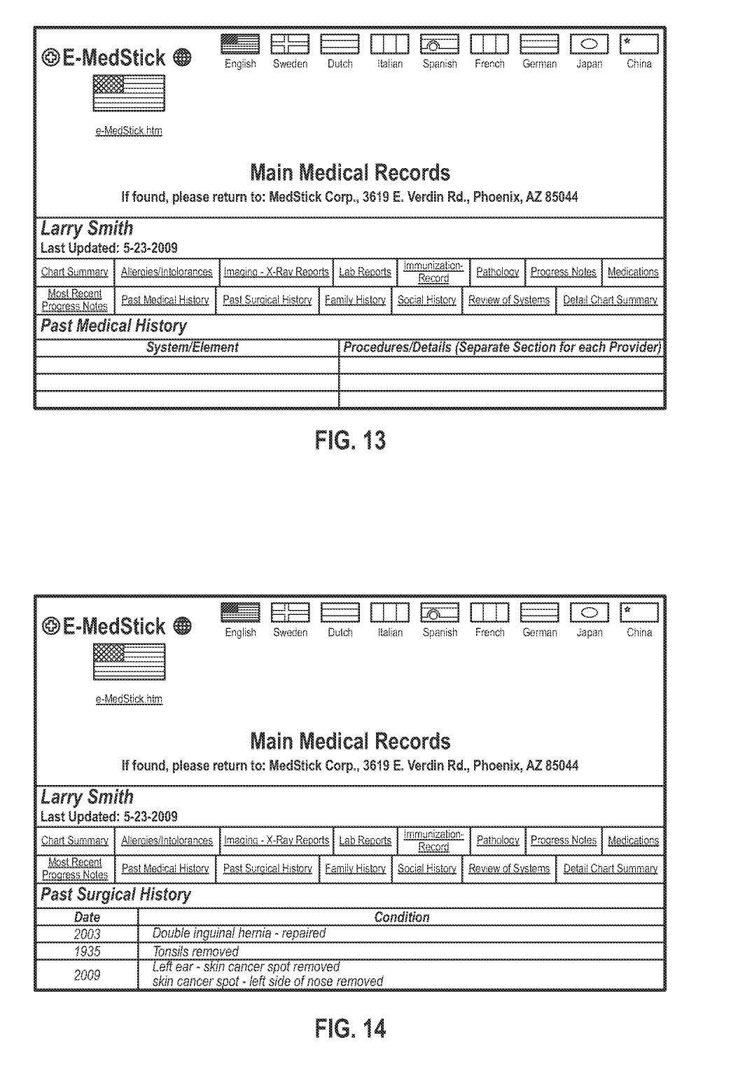

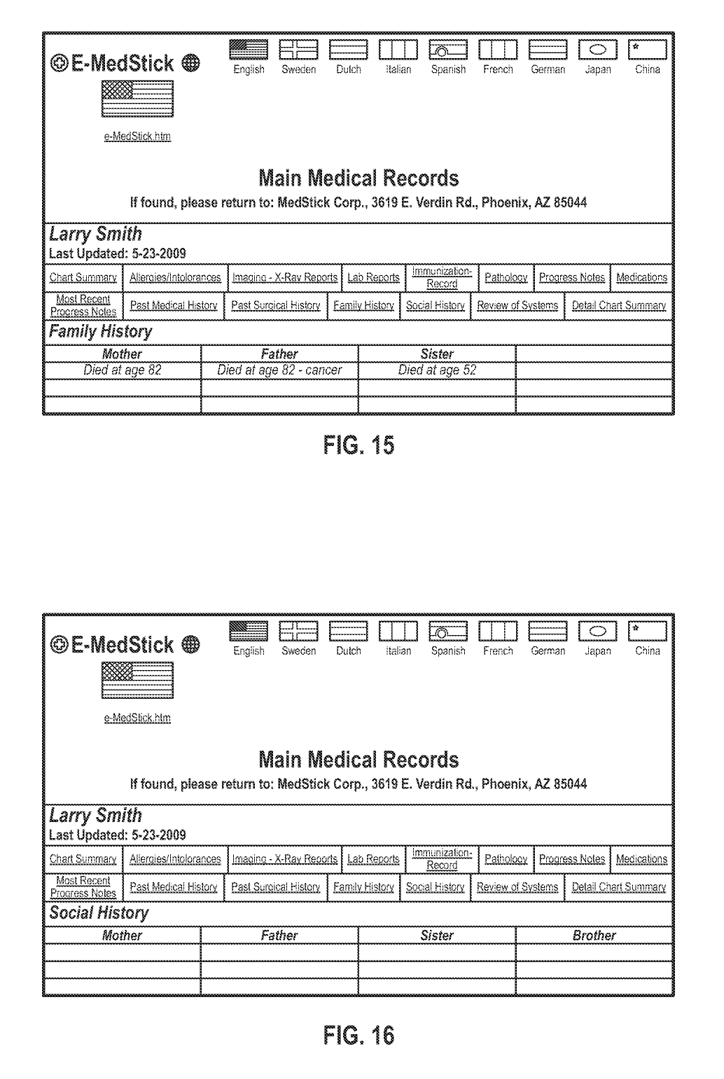

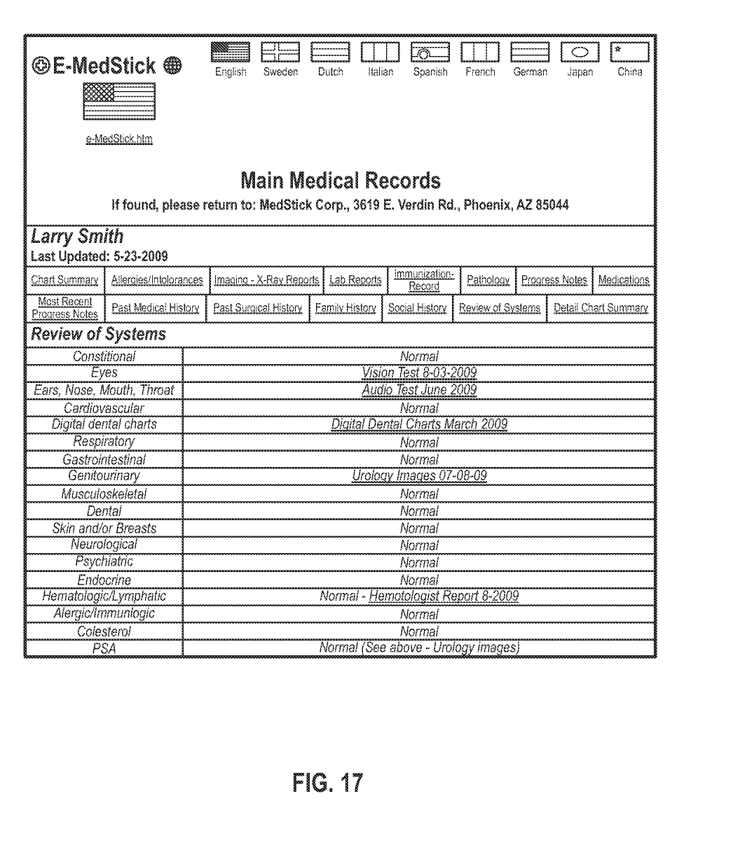

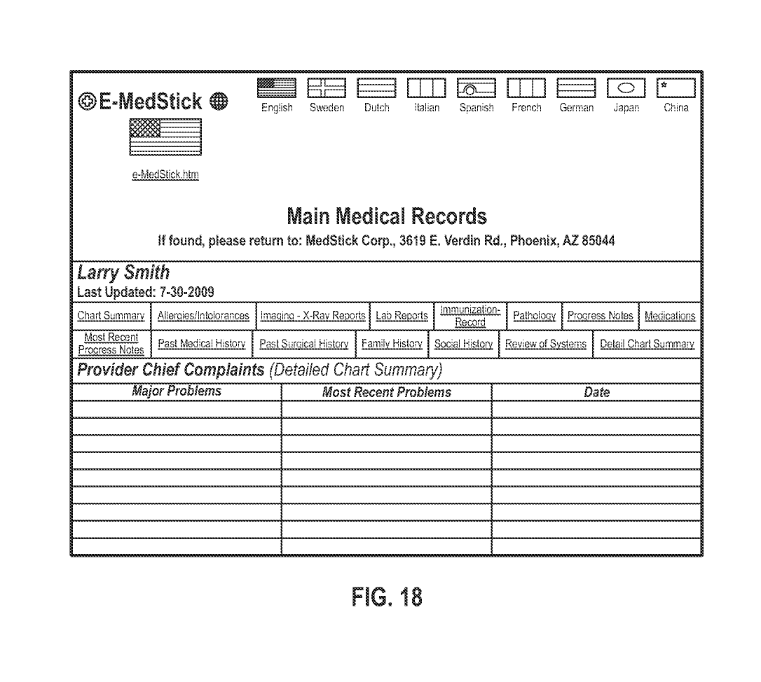

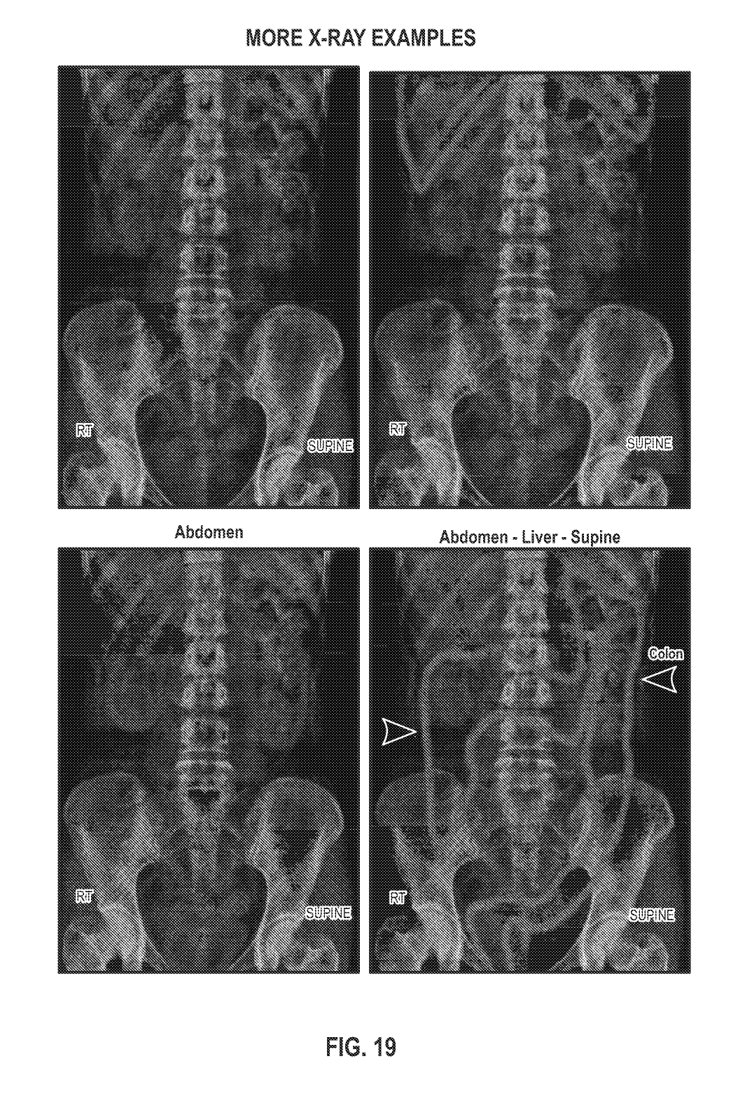

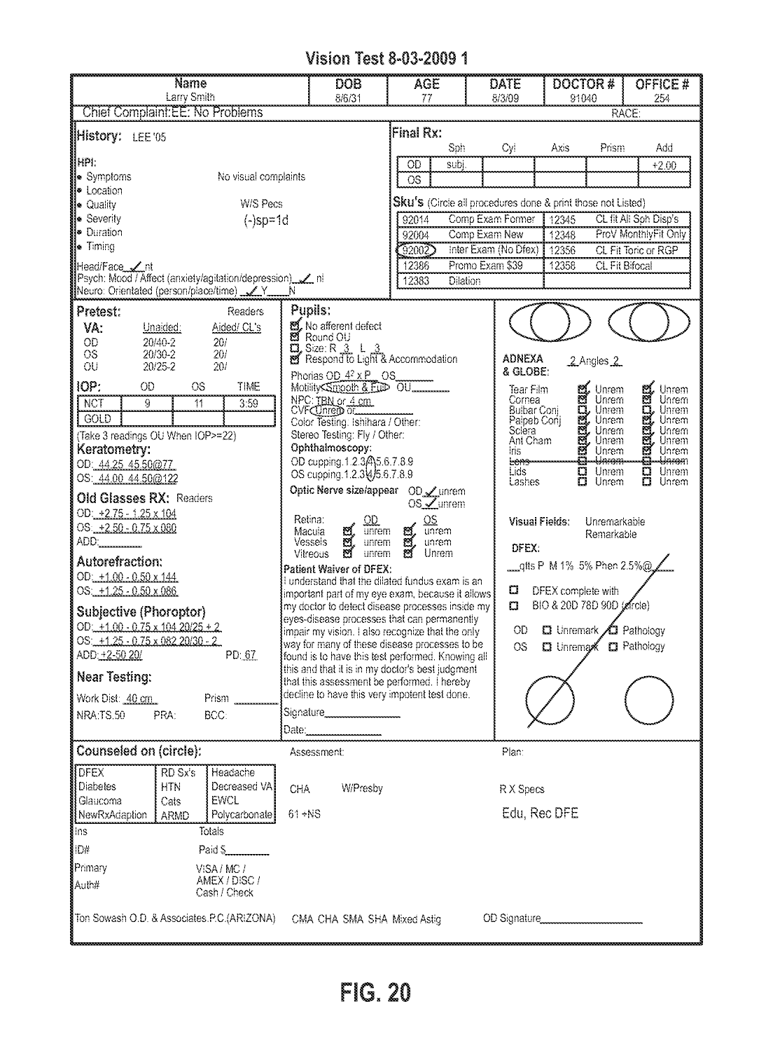

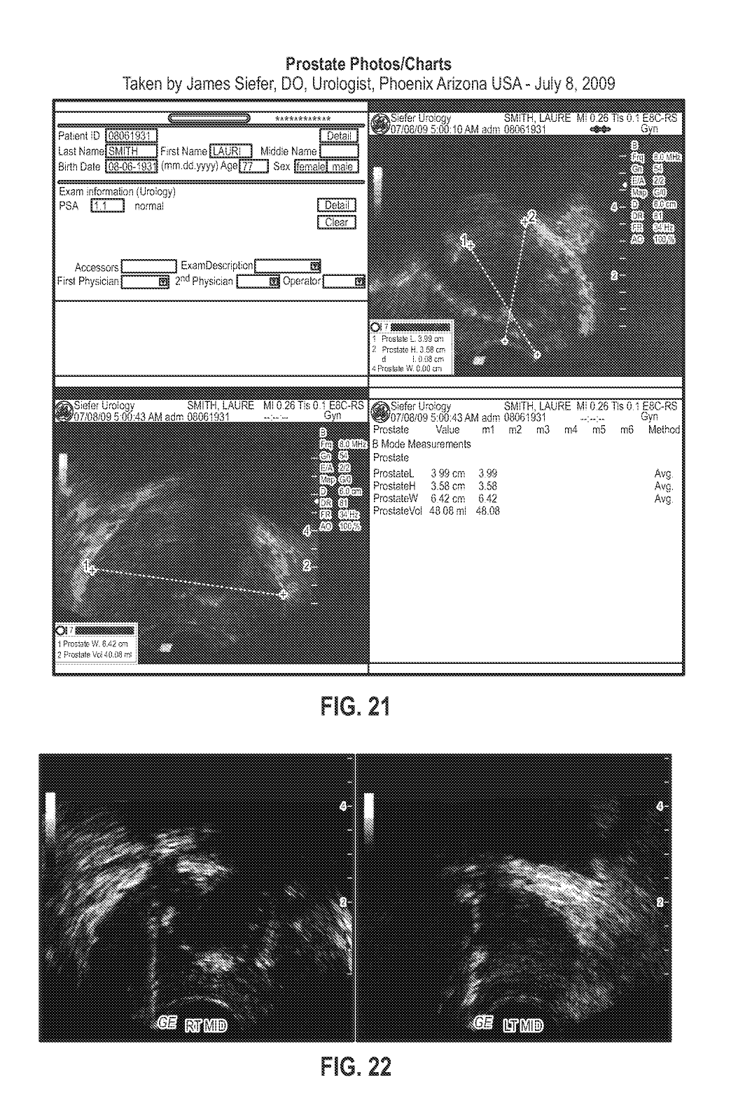

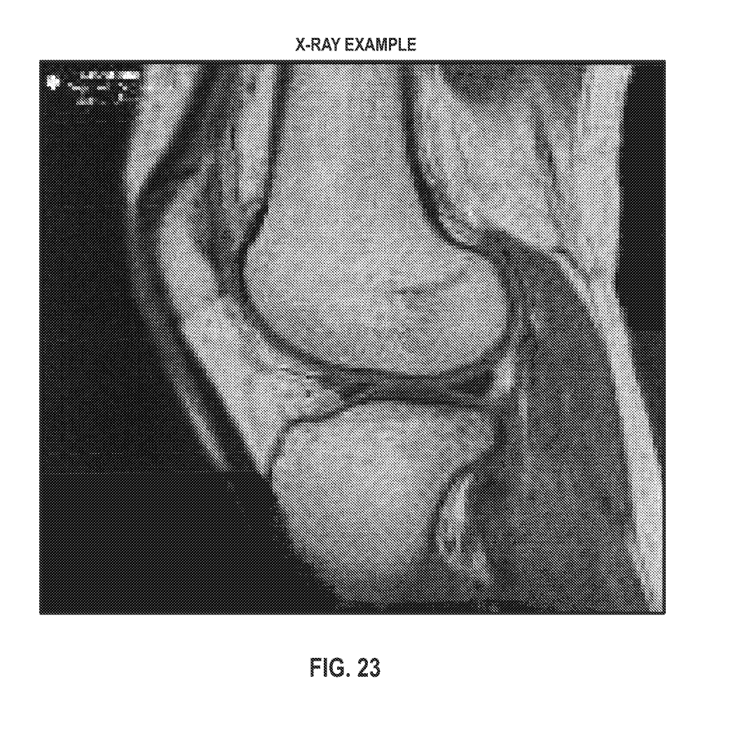

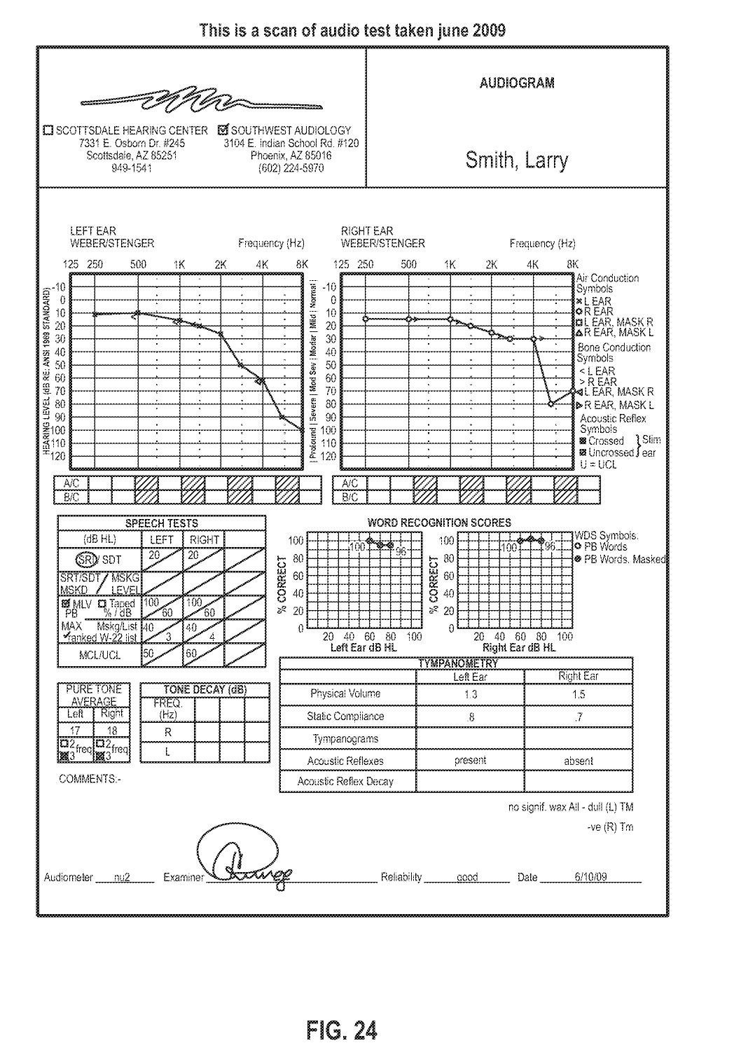

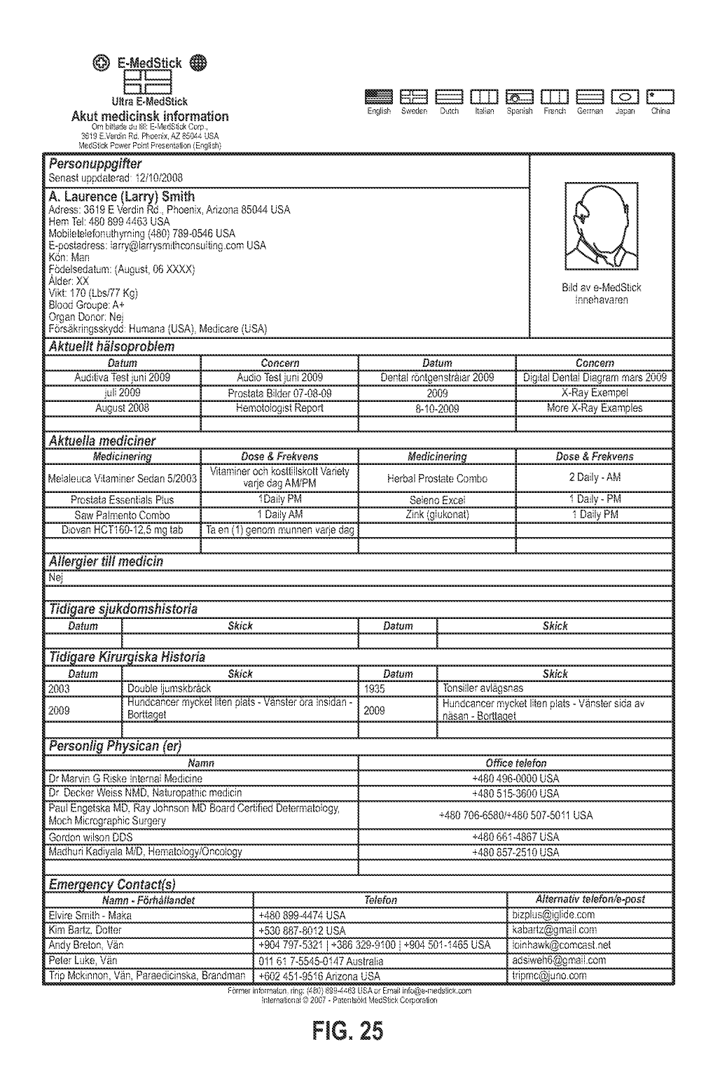

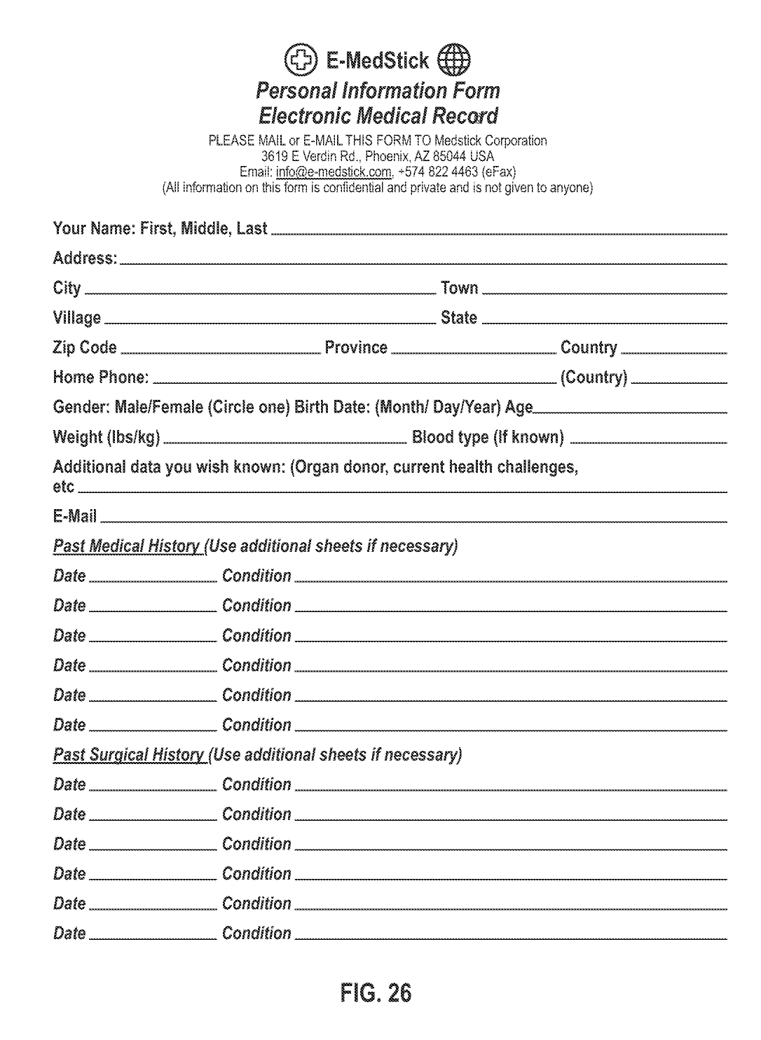

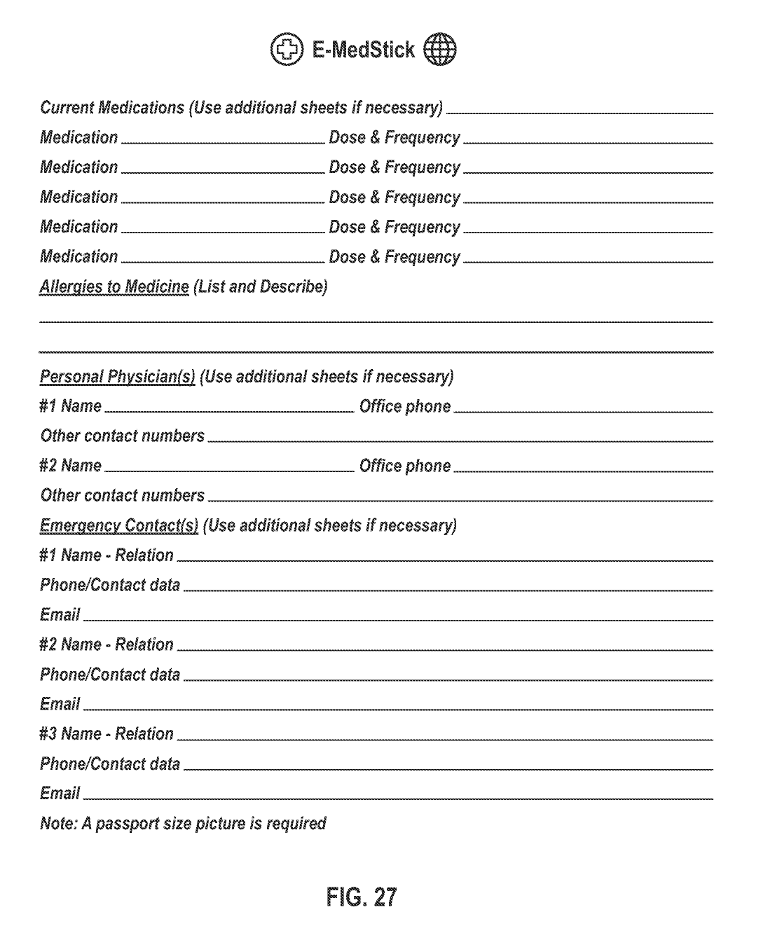

### DETAILED DESCRIPTION AND EXEMPLARY EMBODIMENTS

Despite the many benefits of Electronic Medical Records (EMR), it appears that many vendors and suppliers of HIS systems do not understand what a truly integrated system means to the provider and the patient. The focus on the provider has been unsuccessful. The focus should be the patient.

The E-MedStick is an invention that allows the patient to carry his or her personal medical records in a portable electronic format. In one embodiment, the E-MedStick is a small USB drive containing all of a patient's medical information from all of his or her medical providers; it easily informs paramedics and ER staff of a patient's medical history, even if he or she cannot speak. The medical service provider plugs the USB drive into a laptop at an emergency location and instantly views the patient's medical list and medical allergies, as well as current health concerns, pertinent medical history, surgical history, blood group/type, organ donor status, name of the primary physician, and/or emergency contacts.

This invention avoids the problem of not having a complete medical history at the time of an emergency because the patient carries his complete medical record on a flash drive. This is particularly useful when the physician or care provider does not have an EMR system installed. Instead, the patient maintains his own EMR system through the affordable E-MedStick—which is everything the physician or care provider would have but without the tremendous cost. In one embodiment, a physician or care provider can give an E-MedStick to each of their patients and receive the-same and more benefits as if they the care provider had it installed themselves.

Review of the records on the E-MedStick eliminates duplicate procedures and processes and can save time and money. In one embodiment, information available on the E-MedStick is used in preparation for appointments. In another embodiment, the information available on the E-MedStick is used to address health care issues and planning. In an alternative embodiment, the primary care physician can be immediately contacted through the E-MedStick data in case the patient is incapacitated.

This inventive approach to EMR reduces the chance of a medication error such as giving aspirin to an aspirin allergic patient, or any number of similar challenges that lead to errors. In addition, the use of the E-MedStick simplifies and speeds up the intake process by providing the patient's medicine list instantly to the ambulance or ER staff. This can prevent or even avoid unnecessary testing by listing recent lab tests, MRI, stress echoes or angiography already completed.

Each family member uses a separate E-MedStick. In an alternative embodiment, each family member has a profile on a single E-MedStick. This can save a patient's life or the lives of his loved ones.

Because all of the patient's medical records from various providers are in one location, continuity of care is maintained. Each healthcare provider can now see exactly what other providers are doing for the patient. All the providers are “on the same page”. No other system provides this ease in health care planning between multiple providers.

From the perspective of professional liability, the computerized electronic medical record (EMR) poses substantially less risk than multiple medical histories in different locations, all with different, or contradictory, information. A physician in an emergency room using the E-MedStick can access vital data instantly without having to go to the Internet, and check a patient's allergies or prescription medications, even if the patient is unable to describe or recall his or her medical history and medications and even if the physician or medical facility do not have full computerization. The electronic record on the E-MedStick improves patient care by ensuring correct information, such as proper medication or dosage and other data, is easily quickly retrievable and legible.

A special portable tiny travel drive holds your current and extended medical records in electronic form—easy plug-in to a USB port on any computer and your data comes up on the screen immediately for those treating you. Paramedics, ER, EMS, hospital and others can instantly view latest data. The invention provides data not normally available in emergencies, thus enabling one to have the best appropriate treatments in the shortest time possible at the least cost.

Today most every computer around the world is equipped with a USB Port—enabling the E-MedStick to be easily accommodated.

Each flash drive has the option of several memory sizes: 128 Megabytes, 512 megabytes, 1 gigabyte, or 2 gigabytes. The reason for different sizes is that the amount of medical information may vary according to medical activity regarding each patient. Each unit is waterproof and rugged. In one embodiment, a unit is utilized because of its capabilities as to size, ease of handling and waterproofing. In another embodiment, the flash drive is on wristband. In another embodiment, the flash memory of cellular telephone stores the E-MedStick product. In the USA there are about 276 million that have cell phones. This extensive language support also would do well for all other countries.

X-rays and other graphics are easily stored on the E-MedStick. In one embodiment, the E-MedStick has a special program which takes each graphic and sizes it down without reducing visibility or resolution so it fits easier on the E-MedStick so that more such files can be stored.

This is just like having medical records online except that E-MedStick travels with the patient for immediate use; there is no need to connect to the internet. The E-MedStick promotes accurate medical diagnosis and treatment and greatly helps to minimize inaccurate drug prescriptions and treatments which could lead to costly errors and even death.

With a click of the mouse the innovative software automatically translates your medical information into multiple languages from the professionally translated database.

In one embodiment, legal documents pertaining to healthcare are stored on the E-MedStick, including advanced directives, living wills, and/or power of attorney. In an alternative embodiment, this may include organ donor information and blood type.

Because it is so easy to carry, the E-MedStick is stored in pockets, purses, and/or in vehicles. The patient carries complete medical records including charts, graphics, and scans in a multi-lingual format accessible virtually anywhere in the world. The security measures limit access to authorized individuals; this reduces stress and provides peace of mind. It is ideal for those who travel and for everyone wherever they go!

In order to set up the E-MedStick account, a patient, or the physician for his or her patients-registers at the E-MedStick Internet Web Site. Registration requires creation of a user Identification (ID) and a Password via a special computer program designed specifically for this operation. Such information is kept by the patient and authorized users entrusted with this information. Such authorization is usually limited to the emergency contacts.

After registration, the patient pays for the E-MedStick which includes purchasing one or more formatted E-MedStick flash drives. Payment is made on-line by credit card, money order or check. After confirmation, the computer program directs the patient to the data input page. The patient can defer entry of medical records and instead continue at a later time. Once this is confirmed the program continues.

The process is simple, straightforward and easy, yet all inclusive and very specific because it utilizes only certified medical data that comes straight from medical charts and forms for each specific patient. This medical data is on file with the patient's providers.

Medical records on the E-MedStick are now the focal point, not the existing or non-existing electronic records in the health care provider system, or the EMR system the provider may or may not have, and are current, correct and immediately available from the patient and their E-MedStick. The patient is now responsible for their own health care. The same records on the E-MedStick appear the same to each and every provider—and they work equally as easily with one or another because the patient with his E-MedStick is now the integration focal point. Plus—the E-MedStick EMR can now easily be updated with the information immediately available. Each provider can then choose which system they feel will perform the best for them and yet they will in essence have a totally integrated system when the patient and their E-MedStick is plugged into the provider system.

Information is entered in the native language of the client/patient and automatically translated into other languages by the program. Languages at this point consist of English, Swedish, Dutch, Italian, Spanish, French, German, Japanese and Chinese. Other languages can be added. These languages and their flags appear on the first or emergency screen as well as the detailed screens when the record comes up in the native language of the patient.

While this information is for the most part kept by the physician or medical service provider, it is however the property of the patient and is unique for each and every patient—thus cannot be classified as just data. Such medical files may include various graphics such as x-rays, scans by various medical equipment, etc.

Such data is input to the E-MedStick in a very specific format. The format conforms to HIPAA and HL7 requirements and is capable of conforming to other specific format requirements as may be developed by the industry, including international standards. The process of accessing and placing that data including accuracy and security is an important part of the unique process.

The E-MedStick is safe, secure, and fully encrypted. It contains a photo, ID, and is password protected in addition to being HL7 and HIPAA compliant. Thus emergency and medical data from all providers is instantly available, easy to update, and compatible with hospitals and all providers. The safety of the patient's medical records is ensured because in addition to the password protection, sensitive Social Security Administration numbers as well as driver's license information are not collected. Furthermore, no Internet or data vault access required because all operating system programs reside on the E-MedStick.

The E-MedStick is instantly recognized by all HIS systems. As the patient moves from one provider to another, the E-MedStick makes possible Continuity of Care between all healthcare providers. If there is no patient, the costly implementation of an EMR system for the provider is worthless. Moreover, most EMR systems do not talk to other EMR systems. This is a significant challenge for continuity of care. Nonetheless, if each patient has his own EMR in the form of the E-MedStick then there will be no challenges when going to any provider as long as that provider has a computer with a USB port.

The patient or the health care provider can initially enter medical information via a web site into the specific account initially established by the patient or physician. Alternatively, the patient or health care provider can enter the medical information into a special form provided for this purpose. A trusted family member or friend can also enter the medical information through the web site or special form. If these methods are not available then MedStick Corporation can enter the information.

Once the E-MedStick account has been created and information entered and paid for, a receipt is sent to the patient. At the same time the actual E-MedStick is sent to the patient in a specific package. The operational programs for the E-MedStick are placed on the E-MedStick with explicit instructions for use without an internet connection. Such instructions pertain to the loading of the E-MedStick with medical data.

When the E-MedStick is received by the patient they are instructed to place the E-MedStick in the USB port of his or her computer. The patient can also give it to his or her doctor, physician, or healthcare provider for this operation. The patient can go to the “Download Data to the E-MedStick” area in the web site. They then select the USB Port and download their data including their photo. This data is all placed automatically onto the E-MedStick by the MedStick server. The patient logs off and the process is then complete.

In an alternative embodiment, if the patient has already completed the document sent after purchasing the E-MedStick, they then can upload that data to the E-MedStick web site where it is automatically formatted and/or translated into several languages, and downloaded to the E-MedStick.

Specific and unique programs tailored to the E-MedStick and designed to effectively operate the process are placed on the E-MedStick so that there is no need to connect to the Internet. The E-MedStick can be connected to the Internet but in time of emergencies, Internet access is not required.

Our planning includes that of having in the USA our main servers with, depending upon volumes, separate servers in each state and country. In addition, there will also be separate servers (one or more) in each country. Servers are located only to provide the best service possible rather than having to wait for slow response as is often the case with the Internet and could be an important factor in an emergency medical situation.

Updating of the E-MedStick can occur at anytime and for any reason such as changes in medications, address changes, addition of or switching to a different health care provider, an emergency where certain procedures and other specific health care processes took place, etc. The E-MedStick is extremely flexible and easily fits the requirements of the patient or health care provider.

Firemen, policemen, and paramedics are trained to recognize and to search for the E-MedStick when there is an emergency. In one embodiment, this includes a small card similar in size to a business card with information as to what they should be looking for from the patient in an emergency. Such cards can be in multiple languages for the bearer.

There are two specific parts of the E-MedStick consisting of data for emergencies and data relating to specific details from each health care provider.

The emergency information is not secured by a password. The patient's detailed medical files however are secured by a password. The emergency information can be viewed without a password because otherwise paramedics would not be able to access it and treat the patient. The emergency information which comes up on the computer screen without a password is designed for use by those who need that information promptly in order to stabilize the patient or transport him or her to the nearest medical facility. Such emergency users include policemen, paramedics, emergency rooms, and firemen.

Several safety features are built-in. In one embodiment, when information from the E-MedStick is viewed it cannot be changed. Only the user who has his own private ID and password can change the information. In another embodiment, information on the E-MedStick can be changed by another person to whom the patient provides the log-on information.

In an alternative embodiment, data on the E-MedStick is encrypted for security as well and a photo of the E-MedStick user is included to eliminate possible identity theft and fraud. The E-MedStick does not contain the patient's Social Security number, driver license, or insurance policy numbers in order to reduce identity theft and other such challenges. In yet another embodiment, insurance data is stored on the E-MedStick for use in an emergency. Policy information for auto, fire, home, life, and health insurance is stored on the E-MedStick.

The E-MedStick automatically translates medical records into other languages including English, Swedish, Dutch, Italian, Spanish, French, German, Japanese and Chinese. Other languages can be added. These languages and their flags appear on the first or emergency screen as well as the detailed screens when it comes up in the native language of the patient. At that point should the country or location of the patient be different than the native language, the paramedic, EMT or emergency crew may click once on the flag of the desired country and the information automatically comes up on the screen in that language.

This feature makes the E-MedStick work in the international arena very easily. This part of the Process is most important and in addition to the entire process makes the E-MedStick unique. Another advanced feature that makes the E-MedStick unique is that it is formatted in a specific way and the information is in very specific files and formats understood by the medical industry.

Data for emergencies is for quick and easy access to important information at the emergency site/location for use by EMT, paramedics, emergency personnel, and for use by the medical facility where the patient is taken. In one embodiment, such information comes up immediately on the computer screen and does not require authorization to view.

This information is shown on the emergency page which comes up immediately when inserted into the USB port of the computer; the computer must be in Windows® mode. When the E-MedStick is withdrawn from the USB port of the computer information appearing on the computer screen disappears automatically under program control. In addition, the program prevents date from being copied. Special program commands are included on the E-MedStick for these functions.

Emergency data consisting of the following is entered into the special computer programs or into the document provided with each E-MedStick:
Name, First, Middle, Last
Address including street number, city, village/town, providence, state and country
Telephone number, cell phone number, or best way to contact the individual
Gender (Male or Female)
Birth date (Month, Day, Year)
Age
Weight (lbs/kg)
Blood Type/Group
Organ Donor (Yes or No)
Insurance data (consisting only of company names—no policy numbers)
Current Health Concerns
Current Medications—Medication, Dose and Frequency
Allergies to Medications
Past Medical History (Brief)—Date, Condition
Past Surgical History (Brief)—Date, Condition
Personal Physicians/providers—Name, Contact address, telephone numbers
Emergency Contacts—Name/Relation, Telephone numbers, Other/e-mail
Photo of the e-MedStick holder—this is a requirement

The Ultra E-MedStick includes all detailed data from all of the patient's providers consisting of x-ray charts, scans, lab tests, MRI and all other medical data available for or pertaining to the specific patient. In one embodiment, this information requires an ID and password to access.

When detailed information is needed by specialists or others, the link to the detailed section of the Ultra E-MedStick is used. The ID and password is entered before the system permits access. This can be obtained from the patient. If however the patient cannot speak, then one of the emergency contacts should be able to provide the ID and password.

Detailed data includes writing, notes, graphics, x-rays, scans and any other data that is of concern for a specific patient. This data is contained in the following specific pages on the E-MedStick.
Chart Summary
Allergies and Intolerances
Imaging and X-Ray Reports
Lab Reports
Immunization Record
Pathology
Progress Notes
Medications
Most Recent Progress Notes
Past Medical History
Past Surgical History
Family History
Social History
Review of Systems
Detailed Chart Summary

In case the E-MedStick is ever lost or stolen the patient notifies the MedStick Corporation via email, phone or go on-line. Unauthorized users attempting to use it are locked out. In one embodiment, unauthorized users are locked out from the detailed medical information anyway as they do not have the patient's private ID and password. In another embodiment, information from the E-MedStick which is viewable without the ID or password cannot be changed. Furthermore, the database cannot be changed except by the patient or the person entrusted with the ID and password. The terminology used herein is for the purpose of describing particular embodiments only and is not intended to be limiting of the invention. As used herein, the singular forms “a”, “an”, and “the” are intended to include the plural forms as well, unless the context clearly indicates otherwise. It will be further understood that the terms “comprise” and/or “comprising”, when used in this specification, specify the presence of stated features, integers, steps, operations, elements, and/or components, but do not preclude the presence or addition of one of more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variation will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

While the preferred embodiment to the invention has been described in an illustrative manner, it is to be understood that the terminology which has been used is intended to be in the nature of words of description rather than words of limitation. Many modifications and variations of the invention are possible in light of the above teachings. Therefore, within the scope of the appended claims, the invention may be practiced other than as specifically described.

1. A device for storing a patient's medical records, comprising:
a. a flash drive configured to connect to a USB port and be read by a computer;
b. a record of emergency patient data including photo stored on the flash drive and displayed immediately by the computer when the flash drive is inserted into the USB port; and
c. a record of detailed data stored on the flash drive and displayed upon entry of a password and identification.

2. The device of claim 1, wherein the patient uploads the record of emergency data to the flash drive.

3. The device of claim 1, wherein the record of emergency data is remotely recorded to the flash drive over an internet connection between the flash drive and a central server.

4. The device of claim 1, wherein the flash drive is installed in a cellular telephone as flash memory configured to communicate wirelessly with a central server.

5. The device of claim 1, further comprising a multiplicity of profiles on a single flash drive, wherein each profile contains a record of emergency data and a record of detailed data for one patient.
